(19) United States
(12) Patent Application Publication
(10) Pub. No.: US 2004/0043898 A1
(43) Pub. Date: Mar. 4, 2004

(54) Method for producing catalyst body and carrier having alumina carried thereon

(76) Inventors: Naomi Noda, Ichinomiya-city (JP); Junichi Suzuki, Kuwana-city (JP); Kanji Yamada, Chita-gun (JP)

Correspondence Address: Oliff & Berridge, PO Box 19928, Alexandria, VA, 22320, US

(21) Appl. No.: 10/363,650

(22) PCT Filed: Sep. 6, 2001
(86) PCT No.: PCT/JP01/07717

(30) Foreign Application Priority Data
Sep. 8, 2001 (JP) 200-27410
Jun. 13, 2001 (JP) 2001-179248

(51) Int. Cl. B01J 23/58

(52) U.S. Cl. 502/328; 502/330

(57) ABSTRACT

A catalyst carrying a catalyst material containing an alkaline metal and/or an alkaline earth metal on a carrier and used as an NOₓ trap catalyst for purifying automobile exhaust gas and the like comprises alumina incorporated into the carrier and/or placed between the carrier and the catalyst material, thereby suppressing the deterioration of the carrier caused by the metals such as Li, Na, K and Ca to be used as an alkaline metal and/or an alkaline earth metal and enabling it to be used for a extended period of time.

### TECHNICAL FIELD

The present invention relates to a method for producing a catalyst and a carrier for carrying alumina usable therefor. The present invention relates, more particularly, to a method for producing a catalyst in which there is employed a catalyst material containing an alkaline metal and/or an alkaline earth metal, particularly, Li, Na, K or Ca; said catalyst material being represented by an NOₓ trap catalyst for purifying automobile exhaust gas, thereby suppressing the deterioration of a carrier caused by an alkaline metal and/or an alkaline earth metal to enable extended periods of use and a carrier for carrying alumina.

### BACKGROUND ART

Emission control has been tightened in recent years, so that a lean burn engine and a direct-injection engine have become prevalent, and an NOₓ trap catalyst capable of effectively purifying NOₓ in exhaust gas in a lean atmosphere has been commercialized. As an NOₓ occluding component used for the NOₓ trap catalyst, alkaline metals such as K, Na, Li and Cs, alkaline earth metals such as Ba and Ca, rare earths such as La and Y and the like are known. In particular, Ba has been widely used from the beginning of the commercialization of the NOₓ trap catalyst. Addition of K, which has good NOₓ occluding capability, has been tried recently.

Incidentally, the NOₓ trap catalyst is typically composed of a catalyst material containing the above-described NOₓ occluding component supported by a carrier made of an oxide-based ceramic material such as cordierite or a metallic material such as a Fe—Cr—Al alloy. These carriers have problems of being corroded and easily deteriorated by alkaline metals and a part of alkaline earth metals activated in a high temperature of exhaust gas, particularly, by Li, Na, K and Ca. In particular, in the case of a cordierite carrier composed of an oxide-based ceramic material, there are serious problems such as occurrence of crack by reacting with the above-described alkaline metals or the like.

For an exhaust gas purification catalyst, an activated alumina has been used for a supporting base material having a high specific surface area for highly dispersing catalytically active components typified by precious metals. However, an object of the present invention is different in that a catalyst supporting a catalyst material containing an alkaline metal and/or an alkaline earth metal on a carrier is applied with an alumina basecoat on the carrier before supporting the catalyst material to protect the carrier represented by a cordierite honeycomb from coming into contact with an alkaline metal and/or an alkaline earth metal in a catalyst layer and by extension to protect it from the reaction with them.

### DISCLOSURE OF THE INVENTION

The present invention has been completed in view of these conventional problems, and it is an object of the present invention to provide a catalyst carrying a catalyst material containing an alkaline metal and/or an alkaline earth metal such as an NOₓ trap catalyst, thereby suppressing the deterioration of the carrier by an alkaline metal and/or an alkaline earth metal to enable extended periods of use.

According to the present invention, there is provided a catalyst carrying a catalyst material containing an alkaline metal and/or an alkaline earth metal on a carrier, characterized in that alumina is incorporated into the body of a carrier and/or placed between a carrier and a catalyst material.

Further, there is provided a method for producing a carrier for carrying alumina, characterized by comprising the steps of carrying alumina on a carrier to obtain a primary carrier for carrying alumina and firing the resultant primary carrier for carrying alumina.

### BEST MODE FOR CARRYING OUT THE INVENTION

In the present invention, the alumina having a low reactivity to an alkaline metal and/or an alkaline earth metal to be used for a catalyst material is incorporated into the body of a carrier or placed between the carrier and the catalyst material in advance. By constituting like this, a carrier is protected from an alkaline metal and/or an alkaline earth metal by the alumina to suppress the reaction with them, resulting in suppressing the deterioration, even if the catalyst is exposed to high temperatures during use.

Alumina is known to have various phases. Stability is important in the present invention, and suitable alumina includes γ-alumina, δ-alumina, η-alumina, θ-alumina, α-alumina and amorphous alumina. Generally, α-alumina is preferred in terms of high corrosion resistance in some use environment, amorphous alumina is preferred in terms of easy formation of a dense protective coat, and γ-alumina is preferred in terms of a good affinity for the catalyst material. Surprisingly, in either case, when an alumina layer having a desired thickness is formed, a desired effect can be exerted substantially without depending on types of the alumina phase.

The form of alumina when it is supported (incorporated or placed) into a carrier has no limitation and may be alone or may be a compound or a mixture with other materials. However, from the viewpoint of corrosion resistance, alumina is preferably included in 90 wt % or higher, more preferably substantially alumina alone (only alumina is placed). When other components are compounded and/or mixed, it is preferable to select those having high corrosion resistance in itself to alkaline metals and/or alkaline earth metals or those having the effect to enhance corrosion resistance or heat resistance of alumina. The concrete sources of alumina includes, from the relation with the supporting technique, for example, the oxide and the like when alumina is to be supported by a solid (powder), and various solutions or dispersions (generally referred to “alumina source-containing liquid” herein below) of the nitrate, the sulfate, the hydroxide, the chloride, the organic salt, the alumina sol and the like when alumina is supported by liquid (solution or dispersion). Particularly, the form of the alumina source, in which no components other than alumina remain in a catalyst by the treatment such as firing, is preferred. The method for placing alumina in a carrier and/or between the carrier and a catalyst material includes methods below.

[A Method for Placing Alumina in a Carrier]

By immersing a carrier in an alumina source-containing liquid having a low viscosity, it is possible to cause the liquid to permeate into a so-called virgin carrier, which has not been coated with a catalyst or the like, to place the alumina source in the carrier. This method is preferably used for a porous carrier, enabling the alumina source to be introduced to the surface of open pores. There may be a technique to add the alumina source in advance to a raw material at the step for preparing a carrier (production step). In this case, the alumina source may be added in the form of solution or dispersion or in the form of a solid (powder) such as the oxide. The added alumina source may form a compound with other raw materials in the production step of the carrier, but preferably it exists as alumina. When comparing the technique for immersing the carrier in the alumina source-containing liquid with the technique for adding the alumina source in advance to a raw material of the carrier, the former is more preferred from the viewpoint of suppressing the exposure of the carrier material or the contact with an alkaline metal and/or an alkaline earth metal in a catalyst material. Naturally, it may be the best way for improving corrosion resistance to use alumina in itself for the carrier material, but in this case it is necessary to control the temperature during using and to limit applications lest the low thermal shock resistance of alumina should become a problem.

[A Method for Placing an Alumina-Containing Intermediate Layer Between a Carrier and a Catalyst Material]

This method is not particularly influenced by whether a carrier is porous or not, different from the case alumina is incorporated into the body of a carrier. As a specific technique, the solution or dispersion having a relatively high viscosity containing an alumina sol can be used for coating a carrier to place alumina as an intermediate layer between the carrier and a layer comprising a catalyst material exerting desired effect. The alumina sol is preferably used for an alumina source in an amount 50% by weight or more of the total as the solid content, more preferably 90% by weight or more, in terms of easily forming a dense intermediate layer. Most preferably, substantially only alumina sol is used. Further examples may include a technique for forming slurry of alumina powders or the like and washcoating to form the intermediate layer, and a technique for adding the alumina sol when forming slurry, which is preferred in terms of preventing peeling of the intermediate layer. When the alumina powders are used, those of various phases are suitably used as described above. Incidentally, when the carrier is porous in these techniques for placing the intermediate layer, part of the solution or the dispersion sometimes penetrate into the carrier through open pores and the like when coating, but it is not a problem.

The technique to support (place) alumina in a carrier and/or between the carrier and a catalyst material is not limited to these, but, in any case, preferably, alumina is first fixed by firing at a temperature of 200° C. or above at a step where the alumina is supported or the like, and thereon there is then provided a layer comprising a catalyst material exerting a desired effect, for example, an NOₓ trap catalyst material containing an alkaline metal and/or alkaline earth metal. When an alumina source other than alumina itself is used for supporting alumina, the firing is preferably carried out at a temperature where the used alumina source decomposes or is oxidized to produce alumina or above.

In addition, it is also possible to cause a desired alumina phase to be developed by controlling the firing temperature. For example, when the α-phase having high corrosion resistance is desired, an α-alumina powder may be coated as a raw material. However, it is also a preferred technique in terms of forming a dense α-alumina phase to facilitate change into the α-phase by supporting the alumina having another phase such as γ-alumina, followed by firing it at a temperature of 1000° C. or above in an air atmosphere. A temperature of 1100° C. or above is more preferable since the change into the α-phase is accelerated. It is also a preferred form that the whole is the α-phase after firing. On the other hand, firing at 700° C. or below is preferable when γ-phase is desired. The control of the alumina phase by the firing temperature is possible at a firing step after the washcoat of a catalyst material. In this case, the firing after the washcoat of a catalyst material also preferably serves as the firing after supporting alumina to simplify steps, but the temperature that can be set needs to be within the range where the catalyst material does not deteriorate.

The supporting of alumina may be carried out in two or more times, if needed. In this case, two or more times of impregnation or coating may be repeated interposing a drying step, followed by firing lastly, or the firing may be applied not only lastly but also between the two or more times of impregnation or coating. Alumina sources, alumina phases, supporting methods, firing conditions and the like may be the same or different for these two or more times. A suitable example may include, for example, impregnating or coating an alumina source followed by firing at a temperature of 1100° C. or above to form a dense α-phase in the first supporting, and impregnating or coating an alumina source followed by firing at a temperature of 700° C. or below to allow to better fit with the catalyst material to be supported thereon in the subsequent second supporting.

The shape of the carrier to be used for the catalyst of the present invention is not particularly limited, and the above-described effect for suppressing deterioration can be achieved upon using the carrier having any shape such as a monolith honeycomb, a pellet, a bead, a ring, and foam. In particular, using a carrier having a honeycomb shape (honeycomb carrier) composed of numbers of through-holes (cells) partitioned by thin partition walls provides the greatest effect.

Suitably used materials for the honeycomb carrier include ceramics such as cordierite and mullite, foil type metals comprising a heat resistant stainless steel such as a Fe—Cr—Al alloy, and a honeycomb structure molded by utilizing powder metallurgy. In particular, the carrier comprising cordierite, which easily reacts with Li, Na, K and Ca, preferably exhibits the best effect for suppressing deterioration.

The shape of through-holes (the shape of cells) of the honeycomb carrier may be any shape such as a circle, a polygon and a corrugated type. The outer shape of the honeycomb carrier may be a specific shape suitable for the inner shape of the exhaust system to be installed.

Although the cell density of the honeycomb carrier is also not limited, the cell density in the range of 6 to 1500 cells/square inch (0.9 to 233 cells/cm²) is preferred for the carrier of a catalyst. The partition wall preferably has a thickness in the range of 20 to 2000 μm. For the thin wall having a thickness of 20 to 200 μm, an alkaline metal and/or an alkaline earth metal easily diffuses from the catalyst material to the center of the wall thickness of the carrier, so that the necessity of the present invention becomes high and the effect for suppressing deterioration increases.

The porosity of the honeycomb carrier is also not limited, but in the case it has a high porosity of 10% or higher, further 20% or higher, an alkaline metal and/or an alkaline earth metal easily diffuses through open pores, so that the necessity of the present invention becomes high and the effect for suppressing deterioration increases.

The amount of alumina to be incorporated into the body of the carrier is preferably from 0.5 to 200 g/L per unit volume of a catalyst. When it is below 0.5 g/L, the effect for suppressing carrier deterioration is small, and when supported on the same carrier as an NOₓ trap catalyst in an amount more than 200 g/L, cells may be clogged in the case a honeycomb carrier is used. The amount of alumina is preferably in the range of 10 to 100 g/L, more preferably in the range of 40 to 80 g/L. In particular, in terms of balancing the prevention of the occurrence of cracks and the prevention of the reduction of the bending strength with a pressure drop, the amount of alumina is preferably in the range of 40 to 80 g/L. Note that the amount of alumina naturally does not include the amount of the alumina to be used for a supporting material having a high specific surface area for highly dispersing the catalytically active components exemplified by precious metals.

The alumina layer to be formed on the carrier has a thickness after firing in the cross section perpendicular in the axial direction of the carrier of 20 μm or less, preferably 10 μm or less when one side of the partition wall is measured at about the center of one side of a cell using an electron microscope. The thickness exceeding 20 μm is not preferred due to the increase of pressure drop.

The particles of alumina sol have an average particle diameter of 100 μm or less, preferably 40 μm or less, more preferably 20 μm or less.

The coating solution has a viscosity of generally 10000 mPa.s or below, preferably 500 mPa.s or below, more preferably 30 mPa.s or below. The viscosity exceeding 10000 mPa.s may cause coating difficult in the case of the carrier having a honeycomb body. The viscosity exceeding 500 mPa.s may cause clogging for some carrier to be used, which requires a caution. The viscosity of 30 mPa.s or below preferably causes appropriate penetration also into the pores of a carrier to form a dense adherent alumina layer.

The alumina sol has a pH of generally 2.0 to 6.0, preferably 3.0 to 5.0. The pH below 2.0 is not preferable, because when the material of the carrier is not acid resistant, it can corrode by immersing in coating liquid. The pH exceeding 6.0 is not preferable because the particles in the sol can cohere.

Other metals may be included in the alumina layer within the range that does not impair the action of alumina according to the present invention. The alumina layer naturally does not include any precious metals for other catalysts. In order to effectively protect the carrier from an alkaline metal and/or an alkaline earth metal or the like, more preferably, the alumina layer is formed as an individual layer between the carrier and the catalyst layer containing at least an alkaline metal and/or an alkaline earth metal. In other words, substantially only alumina layer is preferably formed between the carrier and the catalyst layer containing an alkaline metal and/or an alkaline earth metal. The catalyst layer may naturally include the catalyst other than a so-called NOₓ catalyst, for example, precious metals such as Pt, Pd and Rh for firing hydrocarbon and the like. The catalyst layer including precious metals such as Pt, Pd and Rh may naturally be formed separately on the NOₓ catalyst layer.

The catalyst according to the present invention can also be applied together with other purification materials to be applied to an exhaust gas system, such as an NOₓ trap catalyst material consisting of different components, another catalyst material typified by a three way catalyst, an auxiliary catalyst typified by oxides of Ce and/or Zr and a HC adsorbent. In these cases, they may be mixed with the catalyst material of the catalyst according to the present invention, but supporting by overlapping in a layered form is more preferred in terms of enhancing heat resistance. Further, the catalyst material of the catalyst according to the present invention may be used in an exhaust system as appropriate in combination with those provided as a separate body.

The present invention will now be described based on examples, but the present invention is not limited by these examples.

[Preparation of a Slurry for Loading Alumina]

Slurry A for Loading Alumina:

A commercially available γ-Al₂O₃ powder (specific surface area: 200 m²/g) was added with commercially available Al₂O₃ sol and water and wet-milled in a pot mill to prepare slurry A for loading alumina. The Al₂O₃ sol was added in the amount to provide a solid content (weight of Al₂O₃ contained in Al₂O₃ sol) of 10% by weight of total Al₂O₃ on Al₂O₃ basis. The water was added as appropriate so as to provide the slurry with a viscosity suitable for washcoating.

Slurry B for Loading Alumina:

Slurry B for loading alumina was obtained in a similar manner to the slurry A for loading alumina except using an α-Al₂O₃ powder instead of the commercially available γ-Al₂O₃ powder.

[Preparation of a Slurry for Wash-Coating the NOₓ Trap Catalyst]

A commercially available γ-Al₂O₃ powder (specific surface area: 200 m²/g) was immersed in a mixed solution of (NH₃)₂Pt(NO₂)₂ aqueous solution with KNO₃ aqueous solution, and the solution was pulverized for two hours in a pot mill. The solution was dried up by evaporating water, subjected to dry crushing and calcined in an electric furnace for three hours at 600° C. The thus obtained (Pt+K)-pre-doped γ-Al₂O₃ powder was added with commercially available Al₂O₃ sol and water and wet-milled again in a pot mill to prepare washcoating slurry. The relation of the amount of γ-Al₂O₃ to the amount of Pt and K was adjusted at the step of mixing and immersion, such that Pt is 30 g/cft (1.06 g/L) (weight based on Pt element per honeycomb volume) and K is 20 g/L (weight based on K element per honeycomb volume), when the supporting amount of an NOₓ trap catalyst is 100 g/L (per honeycomb volume) at the step where the honeycomb carrier is applied with washcoating and finally burned. The Al₂O₃ sol was added in the amount to provide a solid content of 5% by weight of total Al₂O₃ on Al₂O₃ basis. The water was added as appropriate so as to provide the slurry with a viscosity suitable for washcoating.

[Preparation of Samples]

### EXAMPLE 1

A cordierite honeycomb carrier (partition wall thickness: 6 mil (0.15 mm), cell density: 400 cpsi (62 cells/cm²), porosity 30%) was first immersed in commercially available Al₂O₃ sol. Extra liquid in the cells was blown out, and then the carrier was dried. The supporting amount of the Al₂O₃ sol was adjusted to 50 g/L (honeycomb carrier volume) after firing. When the desired supporting amount cannot be achieved by one immersion and drying, the immersion and drying step was repeated until it is achieved. A resultant honeycomb body, which is a so-called primary carrier for carrying alumina (referred only to supporting carrier herein below), was calcined for one hour at 600° C. in an electric furnace. After the firing, the honeycomb body was repeatedly subjected as needed to the steps of washcoating the above-described slurry for washcoating the NOₓ trap catalyst (referred to “NOₓ trap catalyst slurry” for short herein below) and drying it until an NOₓ trap catalyst supporting amount of 100 g/L is attained, followed by firing again for one hour at 600° C. in an electric furnace to obtain an NOₓ trap catalyst 1.

### EXAMPLE 2

An NOₓ trap catalyst 2 was obtained in a similar manner to Example 1 except changing the conditions of firing after supporting Al₂O₃ sol to three hours at 1200° C.

### EXAMPLE 3

An NOₓ trap catalyst 3 was obtained in a similar manner to Example 1 except using alumina-supporting slurry A instead of commercially available Al₂O₃ sol. The supporting amount of the alumina-supporting slurry A was adjusted such that the sum of the Al₂O₃ derived from a γ-Al₂O₃ powder and the Al₂O₃ derived from Al₂O₃ sol is 50 g/L after firing.

### EXAMPLE 4

An NOₓ trap catalyst 4 was obtained in a similar manner to Example 3 except changing the conditions of firing after supporting the alumina-supporting slurry A to three hours at 1200° C.

### EXAMPLE 5

An NOₓ trap catalyst 5 was obtained in a similar manner to Example 3 except using alumina-supporting slurry B instead of the alumina-supporting slurry A.

### COMPARATIVE EXAMPLE 1

The cordierite honeycomb carrier which is the same as the one used in Example 1 was repeatedly subjected as needed to the steps of washcoating the NOₓ trap catalyst slurry and drying it until an NOₓ trap catalyst supporting amount of 100 g/L is attained, followed by firing for one hour at 600° C. in an electric furnace to obtain an NOₓ trap catalyst 6.

### EXAMPLE 6

An NOₓ trap catalyst 7 was obtained in a similar manner to Example 1 except repeating twice the steps of immersing the cordierite honeycomb carrier in Al₂O₃ sol, drying the carrier, and firing the honeycomb body for one hour at 600° C. in an electric furnace. The supporting amount of the Al₂O₃ sol was adjusted to be 80 g/L in total after the twice firing.

### EXAMPLE 7

An NOₓ trap catalyst 8 was obtained in a similar manner to Example 2 except repeating twice the steps of immersing the cordierite honeycomb carrier in Al₂O₃ sol, drying the carrier, and firing the honeycomb body for three hours at 1200° C. in an electric furnace. The supporting amount of the Al₂O₃ sol was adjusted to be 80 g/L in total after the twice firing.

[Durability Test]

The NOₓ trap catalyst 1 to 8 obtained as described above were subjected to accelerated durability tests for 30 hours at 850° C. with 10% steam in an electric furnace.

In addition, as a reference example, a cordierite honeycomb carrier, which supports nothing, was subjected to the accelerated durability test in a similar manner.

[Evaluation of the Effect of Suppressing Carrier Deterioration]

For the NOₓ trap catalyst s 1 to 8, the presence or absence and many or few of the cracks in the carriers after the durability test were investigated by the appearance observation and the microstructure observation with an electron microscope. In addition, the initial bending strength and that after the durability test were comparatively investigated. The results are shown in Table 1.

TABLE 1

| | | | % reduction in bending |
|---|---|---|---|
| | Number of | Cracking | strength {(initial strength − |
| | NOₓ trap | (after durability | strength after durability test)/ |
| | catalyst | test) | initial strength} × 100% |
| Example 1 | 1 | nothing | 35 |
| Example 2 | 2 | nothing | 28 |
| Example 3 | 3 | some | 46 |
| Example 4 | 4 | few | 34 |
| Example 5 | 5 | some | 39 |
| Example 6 | 7 | nothing | 23 |
| Example 7 | 8 | nothing | 22 |
| Comparative | 6 | many | 75 |
| Example 1 | | | |
| Reference | Carrier | nothing | 1 |
| Example | only | | |

As shown in Table 1, the NOₓ trap catalyst s 1 to 5 and 7 and 8 (Examples 1 to 7) according to the present invention exhibit suppressed occurrence of the cracks in the carriers and have suppressed reduction of the strength compared with the NOₓ trap catalyst 6 (Comparative Example 1) containing no alumina.

### INDUSTRIAL APPLICABILITY

As described above, the catalyst according to the present invention places alumina, which has lower reactivity to an alkaline metal and/or an alkaline earth metal to be used for a catalyst component, in advance in a carrier and/or between the carrier and a catalyst material, thereby protecting the carrier, even if exposed to high temperature, from an alkaline metal and/or an alkaline earth metal in the catalyst material by the alumina to suppress the reaction with the carrier. Consequently, the deterioration of the carrier by an alkaline metal and/or an alkaline earth metal is suppressed to enable extended periods of use of the catalyst.

1. A catalyst supporting a catalyst material containing an alkaline metal and/or an alkaline earth metal on a carrier, characterized in that alumina is incorporated into said carrier and/or placed between said carrier and said catalyst material.

2. The catalyst according to claim 1, wherein substantially only said alumina is incorporated into said carrier and/or placed between said carrier and said catalyst material.

3. The catalyst according to claim 1 or 2, wherein said catalyst material contains at least one precious metal selected from a group consisting of Pt, Pd and Rh.

4. The catalyst according to any of claims 1 to 3, wherein said carrier is a honeycomb carrier.

5. The catalyst according to any of claims 1 to 4, wherein said carrier is a carrier containing cordierite as a major component.

6. The catalyst according to any of claims 1 to 5, wherein said alumina is alumina contains at least one selected from a group consisting of γ-alumina, δ-alumina, η-alumina, θ-alumina, α-alumina and amorphous alumina.

7. The catalyst according to claim 6, wherein said alumina contains α-alumina as a major component.

8. A method for producing a carrier for carrying alumina, characterized by comprising the steps of:
supporting alumina on a carrier to obtain a primary carrier for carrying alumina; and
firing the resultant primary carrier for carrying alumina.

9. The method for producing a carrier for carrying alumina according to claim 8, comprising the step of firing said primary carrier for carrying alumina before supporting a catalyst material.

10. The method for producing a carrier for carrying alumina according to claim 8 or 9, comprising the step of firing said primary carrier for carrying alumina at a temperature of 200° C. or above.

11. The method for producing a carrier for carrying alumina according to any of claims 8 to 10, comprising the step of firing said primary carrier for carrying alumina at a temperature where carried alumina changes its phase, or above.

12. The method for producing a carrier for carrying alumina according to any of claims 8 to 11, comprising the step of firing said primary carrier for carrying alumina at a temperature where at least a part of the carried alumina changes its phase to α-alumina or above.
